(19) United States
(12) Patent Application Publication
(10) Pub. No.: US 2022/0172314 A1
(43) Pub. Date: Jun. 2, 2022

(54) IMAGE CAPTURING DEVICE AND METHOD THEREOF

(71) Applicant: PARTILINK INC., Taipei City (TW)

(72) Inventor: KUO-CHOU CHANG, Taipei City (TW)

(21) Appl. No.: 17/220,125

(22) Filed: Apr. 1, 2021

(30) Foreign Application Priority Data
Nov. 30, 2020 (TW) 109142091

(51) Int. Cl. G06T 1/00

(52) U.S. Cl. CPC G06T 1/0007; G06T 2207/10016

(57) ABSTRACT

The present invention discloses an image capturing device and a method thereof. The image capturing device electrically connects to a host device, a display screen and an electronic device. The host device sends a FreeSync signal. The image capturing device includes a scaler module and a video capturing module. The scaler module receives the FreeSync signal from the host device and sends to the display screen. The scaler module converts the FreeSync signal into a fixed frame rate video signal. The video capturing module electrically connects to the scaler module and the electronic device. The video capturing module receives the fixed frame rate video signal, converts the fixed frame rate video signal into a transport format data, and sends the transport format data to the electronic device.

### BACKGROUND

### 1. Technical Field

The present invention relates to an image capturing device and a method thereof; more particularly, the present invention relates to an image capturing device and a method thereof capable of capturing a video having FreeSync signals and distributing the video with FreeSync signals to other electronic devices,

### 2. Description of the Related Art

Conventionally, screen stuttering and tearing might usually occur while rendering gaming contents. To avoid the aforementioned situation, a novel image display technology called FreeSync was developed to adapt video signals with variable frame rates (i.e. FreeSync signals). In order to successfully activate the playback of gaming contents or videos, not only the computer host or the game console is required to have a graphics card supporting FreeSync, but also the display screen is required to support FreeSync technology. In other words, common display screens or electronic devices, such as desktop computers, laptop computers and tablet PCs, can only play video signals with a fixed frame rate, and cannot play videos with FreeSync signals. As a result, image capturing devices currently sold in the market cannot be applied to videos with FreeSync signals.

Generally, a common image capturing method would split an input signal into two signals via a splitter, wherein one of the signals is transmitted to a display screen, and the other is transmitted to an image capturing device for being distributed to other electronic devices by the image capturing device. Conventionally, video game live streaming is achieved by means of the image capturing device. As mentioned above, because image capturing devices (or ICs) currently sold in the market does not support FreeSync technology, neither the computer host nor the game console can transmit FreeSync signals to the image capturing device, such that the image capturing device cannot successfully transmit videos with FreeSync signals to other electronic devices either. In other words, the image capturing device cannot be applied to a game console utilizing FreeSync video technology and therefore the live streaming of its gaming contents cannot be achieved. Therefore, there is a need to provide an image capturing device and a method thereof to mitigate and/or obviate the aforementioned problems.

### SUMMARY

It is an object of the present invention to provide an image capturing device and a method thereof, wherein a scaler module converts a FreeSync signal into a video signal with a fixed vertical scanning frequency, so as to solve the problem that a conventional image capturing device cannot support the FreeSync signal.

To achieve the abovementioned object, the present invention provides an image capturing device, which is electrically connected to a host device, a display screen and an electronic device. The host device sends a FreeSync signal. The image capturing device comprises a scaler module and a video capturing module. The scaler module receives the FreeSync signal from the host device, and sends the FreeSync signal to the display screen. The scaler module converts the FreeSync signal into a fixed frame rate video signal. The video capturing module is electrically connected to the scaler module and the electronic device. The video capturing module receives the fixed frame rate video signal, converts the fixed frame rate video signal into a transport format data, and sends the transport format data to the electronic device.

To achieve the abovementioned object, the present invention further provides an image capturing method, which is applied in an image capturing device. The image capturing device is electrically connected to a host device, a display screen and an electronic device. The host device sends a FreeSync signal. The image capturing device includes a scaler module and a video capturing module electrically connected to each other. The image capturing method comprises the following steps: receiving, by the scaler module, the FreeSync signal; sending, by the scaler module, the FreeSync signal to the display screen; converting, by the scaler module, the FreeSync signal into a fixed frame rate video signal; receiving, by the video capturing module, the fixed frame rate video signal, and converting the fixed frame rate video signal into a transport format data; and sending, by the video capturing module, the fixed frame rate video signal in the form of the transport format data to the electronic device.

According to one embodiment of the present invention, the fixed frame rate video signal has a fixed vertical scanning frequency.

According to one embodiment of the present invention, the scaler module configures the vertical scanning frequency of the fixed frame rate video signal according to a predetermined refresh rate.

According to one embodiment of the present invention, the image capturing device further comprises a universal serial bus (USB). The video capturing module is electrically connected to the electronic device via the USB. Further, the video capturing module sends the fixed frame rate video signal in the form of the transport format data to the electronic device via the USB.

According to one embodiment of the present invention, the image capturing module further comprises a plurality of video signal output interfaces. The scaler module is electrically connected to the host device and the display screen via the plurality of video signal output interfaces. Moreover, the scaler module receives the FreeSync signal from the host device via the plurality of video signal output interfaces, and sends the FreeSync signal to the display screen.

As described above, according to the image capturing device and the method thereof of the present invention, the image capturing device comprises a scaler module and a video capturing module. After the scaler module receives a FreeSync signal from the host device, the scaler module would perform two steps: one step is to send the FreeSync signal to the display screen, such that the display screen may display a video corresponding to the FreeSync signal; the other step is to convert the FreeSync signal into a fixed frame rate video signal, and then to send the fixed frame rate video signal to the video capturing module. Next, the video capturing module converts the fixed frame rate video signal into a transport format data, and sends the transport format data to the electronic device, such that a screen of the electronic device may display a video corresponding to the fixed frame rate video signal. Because the difference between the fixed frame rate video signal and the FreeSync signal is that the former has a fixed frame rate and the latter has a variable frame rate, the screen of the electronic device can display the same video (such as a gaming content) to achieve the effect of live streaming, which makes the image capturing device realize the function of supporting the FreeSync signal.

### BRIEF DESCRIPTION OF THE DRAWINGS

In the drawings, wherein similar reference numerals denote similar elements throughout the several views:

FIG. 1 illustrates a schematic drawing showing an application environment of an image capturing device according to one embodiment of the present invention;

FIG. 2 illustrates a block diagram of the image capturing device as shown in FIG. 1; and

FIG. 3 illustrates a flowchart of an image capturing method according to one embodiment of the present invention.

### DETAILED DESCRIPTION OF THE EMBODIMENTS

In order to make the structure and characteristics as well as the effectiveness of the present disclosure further understood and recognized, a detailed description of the present disclosure is provided as follows, along with embodiments and accompanying figures.

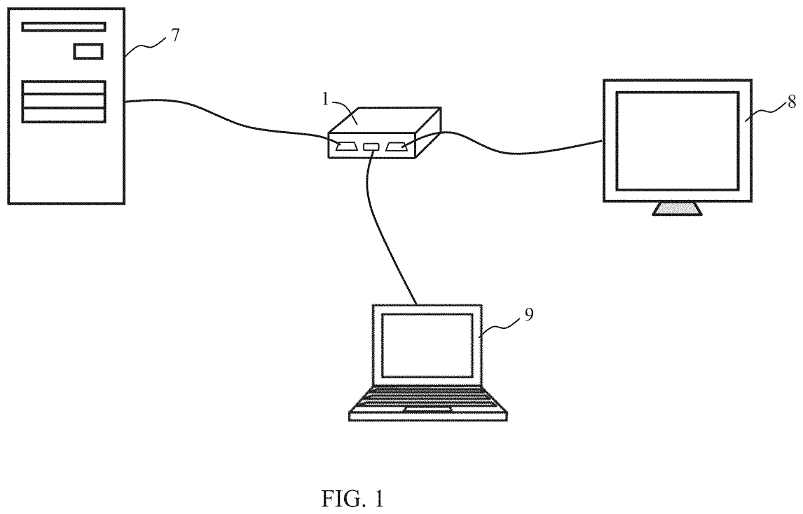

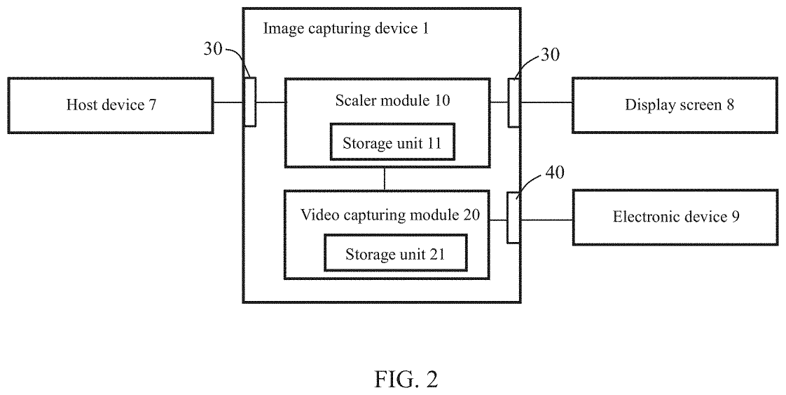

Please refer to FIG. 1 and FIG. 2. FIG. 1 illustrates a schematic drawing showing an application environment of an image capturing device according to one embodiment of the present invention; and FIG. 2 illustrates a block diagram of the image capturing device as shown in FIG. 1. The image capturing device 1 of the present invention is electrically connected to a host device 7, a display screen 8 and an electronic device 9. First, the host device 7 can be, but is not limited to, a game console or a computer host. An input signal sent from the host device 7 to the image capturing device 1 includes a FreeSync signal, The FreeSync signal refers to a video signal with a variable frame rate. In this embodiment, the vertical scanning frequency of the video signal is variable. This so-called FreeSync technique can reduce screen stuttering and tearing.

In this embodiment, the display screen 8 is a screen which supports FreeSync signals. More specifically, a common game player (i.e. a user) would use a display screen 8 which supports FreeSync to pair with a host device 7 (i.e. game console). As a result, the display screen 8 in this embodiment is a screen which supports FreeSync. The electronic device 9 in this embodiment is a general computer which “does not” support

FreeSync. The electronic device 9 can be, but is not limited to, a desktop computer, a laptop computer, a tablet PC or a smart phone.

In this embodiment, the image capturing device 1 comprises a scaler module 10 and a video capturing module 20. The scaler module 10 and the video capturing module 20 are electrically connected to each other for data transportation. In this embodiment, the scaler module 10 is a Scaler IC, which is also a display driver IC capable of supporting FreeSync signals. The video capturing module 20 can be a video capture card capable of storing the video signal as a transportable digital format file, which is called as transport format data in this embodiment.

In this embodiment, the image capturing device 1 further comprises a plurality of video signal output interfaces 30, which can be but not limited to a High Definition Multimedia Interface (HDMI), a DisplayPort (DP) or other equivalent video interfaces. The host device 7 and the display screen 8 can be connected to the video signal output interfaces 30 of the image capturing device 1 in a wired manner, so as to perform video signal transportation with the image capturing device 1. Further, in this embodiment, the scaler module 10 is also electrically connected to the video signal output interfaces 30, such that the scaler module 10 is electrically connected to the host device 7 and the display screen 8 via the video signal output interfaces 30.

Preferably, the image capturing device 1 further comprises a universal serial bus (USB) 40. The electronic device 9 can be connected to the USB 40 of the image capturing device 1 in a wired manner, so as to perform data transportation of the transport format data with the image capturing device The video capturing module 20 is also electrically connected to the USB 40, such that the video capturing module 20 can be electrically connected to the electronic device 9 via the USB 40 for data transportation.

Please note that each of the abovementioned modules not only can be configured as a hardware device, a software program, a firmware or a combination thereof, but also can be configured as a circuit loop or other proper arrangement. The connection between each module can be in either a wired manner or a wireless manner for receiving and sending data. Moreover, each module can be configured either independently or jointly. Further, please note that the abovementioned embodiments only describe preferred embodiments of the present invention. To avoid redundant description, not all possible variations and combinations are described in detail in this specification. However, those skilled in the art would understand the above modules or components are not all necessary parts, And, in order to implement the present invention, other more detailed known modules or components might also be included. It is possible that each module or component can be omitted or modified depending on different requirements; and it is also possible that other modules or components might be disposed between any two modules.

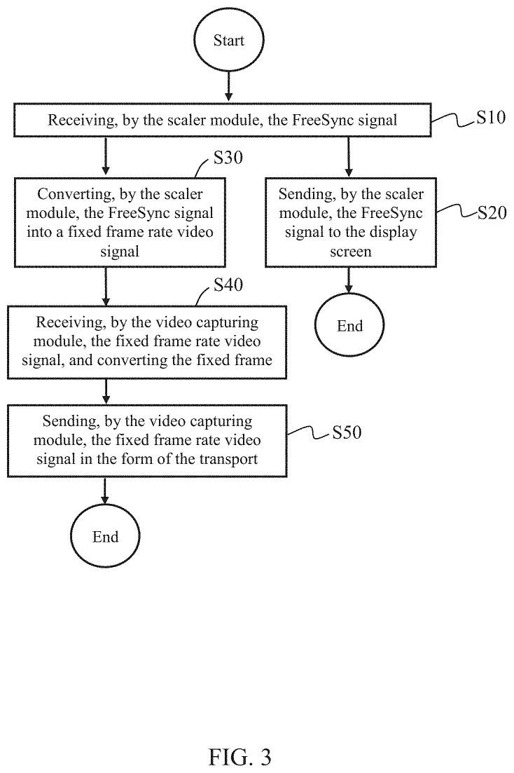

Please refer to FIG. 1, FIG. 2 and FIG. 3. FIG, 3 illustrates a flowchart of an image capturing method according to one embodiment of the present invention. The image capturing method of this embodiment can be applied in the image capturing device 1. The steps and flows of the image capturing method would be described in order hereinafter for further explaining the steps executed by each of the modules of the image capturing device 1, as well as for explaining the correlation among the host device 7, the display screen 8 and the electronic device 9.

Step S10: receiving, by the scaler module 10, the FreeSync signal.

As mentioned above, the host device 7 can send the input signal which includes the FreeSync signal to the image capturing device 1. In this embodiment, after the scaler module 10 receives the input signal via the video signal output interface 30, the scaler module 10 can send the FreeSync signal to the display screen 8 (i.e. Step S20), and perform analysis and conversion of the FreeSync signal (i.e. Step S30).

Step S20: sending, by the scaler module 10, the FreeSync signal to the display screen 8.

As mentioned above, the display screen 8 of this embodiment is a screen that the common game player (i.e. the user) uses to pair with the host device 7 (i.e. the game console); therefore, the display screen 8 can support FreeSync signals, As a result, the scaler module 10 can send the FreeSync signal received from the host device 7 directly to the display screen 8 via the video signal Output interface 30, so that the display screen 8 may display the video accordingly (for example, the gaming content).

Step S30: converting, by the scaler module 10, the FreeSync signal into a fixed frame rate video signal.

Furthermore, the scaler module 10 would also perform analysis and conversion of the FreeSync signal. Specifically, the scaler module 10 of this embodiment has a storage unit 11 stored with a predetermined refresh rate, which is a refresh frequency for a monitor (or a display) of a general screen (i.e. the screen of the electronic device 9 of this embodiment), for example without limiting the scope of the present invention, the refresh frequency is 60 Hz. In other words, the scaler module 10 is predetermined with a monitor refresh frequency for an electronic device 9 commonly sold in the market, In this embodiment, this monitor refresh frequency refers to the predetermined refresh rate.

When the scaler module 10 receives the FreeSync signal, it not only can send the FreeSync signal directly to the display screen 8 (i.e. Step S20), but also can uniformly configure the original vertical scanning frequency of the FreeSync signal as the predetermined refresh rate (such as 60 Hz in this embodiment) for converting it into the fixed frame rate video signal accordingly. In other words, the fixed frame rate video signal. is a video signal with a fixed vertical scanning frequency (such as 60 Hz in this embodiment), wherein the vertical scanning frequency of the fixed frame rate video signal is configured by the scaler module 10 according to the predetermined refresh rate. Then, the scaler module 10 sends the converted fixed frame rate video signal to the video capturing module 20.

Step S40: receiving, by the video capturing module 20, the fixed frame rate video signal, and converting the fixed frame rate video signal into a transport format data.

After the video capturing module 20 receives the fixed frame rate video signal from the scaler module 10, the video capturing module 20 may perform format conversion of the fixed frame rate video signal. That is, the video capturing module 20 can convert the fixed frame rate video signal (or a video signal) into a transport format data. In this embodiment, the video capturing module 20 of the image capturing device 1 performs data transportation with the electronic device 9 via the USB 40. Therefore, the transport format data is a format that can be transported by the USB 40. For example, the format can be in the form of a FAT file system, a NTFS file system, or a HPFS file system. More specifically, the video capturing module 20 may perform procedures such as decompression, decoding, compression and encoding to the fixed frame rate video signal, in order to convert it into the aforementioned transport format data. Preferably, the video capturing module 20 also has a storage unit 21 for storing the transport format data of the fixed frame rate video signal for the electronic device 9 to access.

Step 550: sending, by the video capturing module 20, the fixed frame rate video signal in the form of the transport format data to the electronic device 9.

In this embodiment, the video capturing module 20 sends the fixed frame rate video signal in the form of the transport format data to the electronic device 9 via the USB 40. Specifically, because a general laptop computer or a tablet PC does not have the video signal output interface 30 (such as the abovementioned HDMI interface or DP interface), the image capturing device 1 is electrically connected to the electronic device 9 via the USB 40. Further, by means of the USB 40, the video capturing module 20 can send the transport format data, which is converted from the fixed frame rate video signal, to the electronic device 9. Because the fixed frame rate video signal is a video signal with a fixed vertical scanning frequency, the electronic device 9 is therefore capable of activating the playback of the video (i.e. gaming contents) corresponding to the fixed frame rate video signal.

Therefore, the image capturing device 1 of this embodiment can split the FreeSync signal received from the host device 7 into two FreeSync signals, wherein one of the FreeSync signals is directly sent to the display screen 8, and the other is converted into the fixed frame rate video signal for being sent to the electronic device 9, such that the display screen 8 and the screen of the electronic device 9 may play videos at the same time. As a result, at the time the game player (i.e. the user) plays the game on the display screen 8, the video (or image or frame) can also be sent to the electronic device 9 to achieve the function of live streaming.

As described above, according to the image capturing device and the method thereof of the present invention, the image capturing device comprises a scaler module and a video capturing module. After the scaler module receives a FreeSync signal from the host device, the scaler module would perform two steps: one step is to send the FreeSync signal to the display screen, such that the display screen may display a video corresponding to the FreeSync signal; the other step is to convert the FreeSync signal into a fixed frame rate video signal, and then to send the fixed frame rate video signal to the video capturing module. Next, the video capturing module converts the fixed frame rate video signal into a transport format data, and sends the transport format data to the electronic device, such that a screen of the electronic device may display a video corresponding to the fixed frame rate video signal. Because the difference between the fixed frame rate video signal and the FreeSync signal is that the former has a fixed frame rate and the latter has a variable frame rate, the screen of the electronic device can display the same image (such as a gaming content) to achieve the effect of live streaming, which makes the image capturing device realize the function of supporting the FreeSync signal.

It should be noted that the described embodiments are only for illustrative and exemplary purposes and that various changes and modifications may be made to the described embodiments without departing from the scope of the application as disclosed by the appended claims.

What is claimed is:

1. An image capturing device, electrically connected to a host device, a display screen and an electronic device, the host device sending a FreeSync signal, the image capturing device comprising:
a scaler module, receiving the FreeSync signal from the host device and sending to the display screen, the scaler module converting the FreeSync signal into a fixed frame rate video signal; and
a video capturing module, electrically connected to the scaler module and the electronic device, the video capturing module receiving the fixed frame rate video signal, converting the fixed frame rate video signal into a transport format data, and sending the transport format data to the electronic device.

2. The image capturing device as claimed in claim 1, wherein the fixed frame rate video signal has a fixed vertical scanning frequency.

3. The image capturing device as claimed in claim 2, wherein the scaler module configures the vertical scanning frequency of the fixed frame rate video signal according to a predetermined refresh rate.

4. The image capturing device as claimed in claim 1, further comprising:
a universal serial bus (USB), wherein the video capturing module is electrically connected to the electronic device via the USB, and sends the fixed frame rate video signal in the form of the transport format data to the electronic device via the USB.

5. The touch pad module of claim 1, wherein the suspended portion is farther away from the touch panel than the fixing portion, such that the elastic arm structure forms a convex portion.

6. An image capturing method, applied in an image capturing device, which is electrically connected to a host device, a display screen and an electronic device, the host device sending a FreeSync signal, the image capturing device including a scaler module and a video capturing module electrically connected to each other, the image capturing method comprising the following steps:
receiving, by the scaler module, the FreeSync signal;
sending, by the scaler module, the FreeSync signal to the display screen;
converting, by the scaler module, the FreeSync signal into a fixed frame rate video signal;
receiving, by the video capturing module, the fixed frame rate video signal, and converting the fixed frame rate video signal into a transport format data; and
sending, by the video capturing module, the fixed frame rate video signal in the form of the transport format data to the electronic device.

7. The image capturing method as claimed in claim 6, wherein the fixed frame rate video signal has a fixed vertical scanning frequency.

8. The image capturing method as claimed in claim 7, wherein the scaler module configures the vertical scanning frequency of the fixed frame rate video signal according to a predetermined refresh rate.

9. The image capturing method as claimed in claim 6, wherein the image capturing device further comprises a universal serial bus (USB), and the video capturing module sends the fixed frame rate video signal in the form of the transport format data to the electronic device via the USB.

10. The image capturing method as claimed in claim 8, wherein the image capturing device further comprises a plurality of video signal output interfaces, where the scaler module receives the FreeSync signal from the host device via the plurality of video signal output interfaces, and sends the Free Sync signal to the display screen.
